(19) United States
(12) Patent Application Publication
(10) Pub. No.: US 2024/0329566 A1
(43) Pub. Date: Oct. 3, 2024

(54) DEVELOPING DEVICE AND IMAGE FORMING APPARATUS

(71) Applicant: FUJIFILM Business Innovation Corp., Tokyo (JP)

(72) Inventors: Tatsuya TAMAI, Kanagawa (JP); Atsushi FUNADA, Kanagawa (JP); Mitsutoshi HONGO, Kanagawa (JP); Mizue SEKINE, Kanagawa (JP)

(73) Assignee: FUJIFILM Business Innovation Corp., Tokyo (JP)

(21) Appl. No.: 18/459,923

(22) Filed: Sep. 1, 2023

(30) Foreign Application Priority Data
Mar. 29, 2023 (JP) 2023-053709

(51) Int. Cl. G03G 15/08; G03G 15/00; G03G 15/01

(52) U.S. Cl. CPC G03G 15/0893; G03G 15/0121; G03G 15/0808; G03G 15/6558; G03G 2215/066

(57) ABSTRACT

A developing device, configured to perform development on an image carrier, includes: a loop-shaped developer movement path in which developer is to circulate, the developer movement path including an upper movement path and a lower movement path along each of which the developer is to move, the lower movement path being located lower than the upper movement path; and an inlet through which fresh developer is to be supplied to the developing device. The developer received at the inlet is caused to move along the upper movement path before moving to the lower movement path.

### CROSS-REFERENCE TO RELATED APPLICATIONS

This application is based on and claims priority under 35 USC 119 from Japanese Patent Application No. 2023-053709 filed Mar. 29, 2023.

### BACKGROUND

### (i) Technical Field

The present disclosure relates to a developing device and an image forming apparatus.

### (ii) Related Art

A container device disclosed by Japanese Unexamined Patent Application Publication No. 2018-155873 includes a container that contains developer; a transporting member including a shaft and a transporting portion, the shaft being rotatably supported by the container, the transporting portion being supported by the shaft and configured to transport the developer in the container when the shaft rotates; and a pathway provided in the transporting portion and through which air is allowed to pass in the axial direction of the shaft.

### SUMMARY

In a developing device including a movement path along which developer is to move, the movement path is occasionally supplied with fresh developer.

In a configuration in which developer is to be supplied to a lower part of a developer movement path, the developer supplied to the lower part is then caused to move upward; that is, the movement of the developer is less smooth than in a configuration in which developer is caused to move downward.

Aspects of non-limiting embodiments of the present disclosure relate to moving developer more smoothly than in a configuration in which developer is to be supplied to a lower part of a developer movement path.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a developing device configured to perform development on an image carrier, the developing device including: a loop-shaped developer movement path in which developer is to circulate, the developer movement path including an upper movement path and a lower movement path along each of which the developer is to move, the lower movement path being located lower than the upper movement path; and an inlet through which fresh developer is to be supplied to the developing device. The developer received at the inlet is caused to move along the upper movement path before moving to the lower movement path.

### BRIEF DESCRIPTION OF THE DRAWINGS

An exemplary embodiment of the present disclosure will be described in detail based on the following figures, wherein:

FIG. 1 illustrates an image forming apparatus;

FIG. 2 is a top view of a developing device;

FIG. 3 is a sectional view of the developing device, taken along line III-III given in FIG. 2;

FIG. 4 is a sectional view of the developing device, taken along line IV-IV given in FIG. 2;

FIG. 5 is a sectional view of the developing device, taken along line V-V given in FIG. 2;

FIG. 6 illustrates the developing device with a rotating jig attached thereto;

FIG. 7 is a top view of the developing device with an inlet covering member removed therefrom;

FIG. 8 is a sectional view of the developing device, taken along line VIII-VIII given in FIG. 6;

FIG. 9 is a sectional view of the developing device, taken along line IX-IX given in FIG. 8;

FIG. 10 is a sectional view of the developing device, taken along line X-X given in FIG. 9;

FIG. 11 is a sectional view of the developing device, taken along line XI-XI given in FIG. 6;

FIG. 12 illustrates the developing device mounted on a discharging jig;

FIG. 13 is a sectional view of the developing device mounted on the discharging jig;

FIG. 14 illustrates a set of relevant elements including the jigs; and

FIG. 15 illustrates the movement of developer supplied through a second inlet to the developing device.

### DETAILED DESCRIPTION

An exemplary embodiment of the present disclosure will now be described with reference to the accompanying drawings.

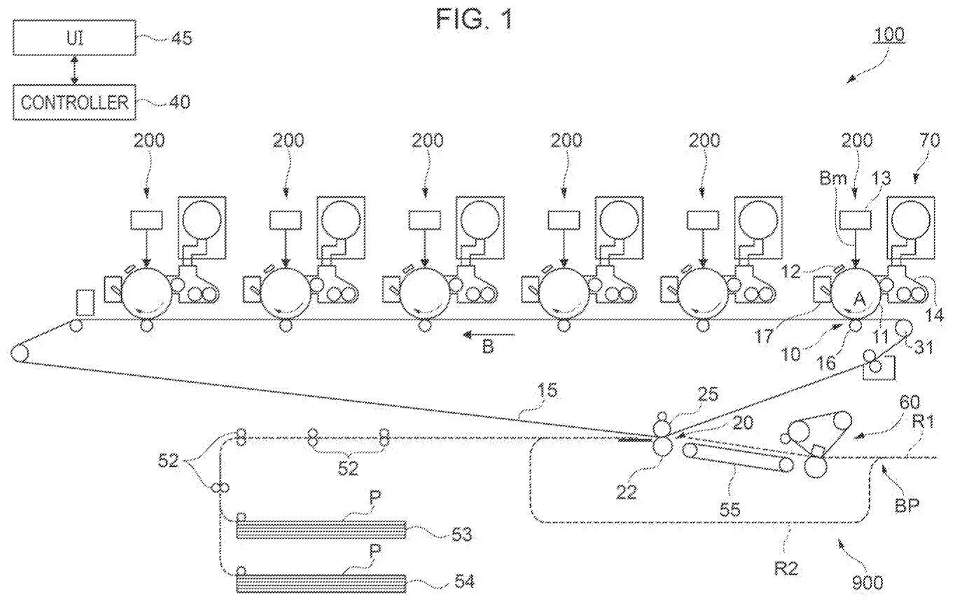

FIG. 1 illustrates an image forming apparatus 100 according to the present exemplary embodiment. The image forming apparatus 100 illustrated in FIG. 1 is viewed from the front side.

The image forming apparatus 100 is of a so-called tandem type and employs an intermediate transfer scheme.

The image forming apparatus 100 includes a plurality of image forming units 200, which are configured to form an image to be transferred to a sheet P, an exemplary recording medium.

Each image forming unit 200 includes a photoconductor drum 11, which is an exemplary image carrier and on which a toner image to be transferred to a sheet P is to be formed by using a developer containing a toner. In other words, the image forming unit 200 is configured to form a toner image to be transferred to a sheet P on the photoconductor drum 11 by using developer particles.

The developer according to the present exemplary embodiment is composed of a dry carrier and a dry toner. The image forming unit 200 forms a toner image on the photoconductor drum 11 by using the carrier and the toner.

The plurality of image forming units 200, six in total, form respective toner images on the respective photoconductor drums 11 by using respective developers that are of different kinds.

In the present exemplary embodiment, four of the six image forming units 200 form toner images from developers having basic colors of yellow, magenta, cyan, and black.

The remaining two image forming units 200 form toner images from developers having nonbasic colors, such as a clear color, white, gold, silver, pink, green, orange, and the like.

The developers having nonbasic colors may each alternatively be a developer containing a magnetic toner, or a developer containing an electrically conductive toner. Furthermore, a developer containing a toner that emits light by receiving light such as ultraviolet light or infrared light may also be employed as a developer having a nonbasic color.

While the present exemplary embodiment employs a so-called two-component developer that is a mixture of a carrier and a toner, the developer is not limited thereto and may be a so-called single-component developer composed of a toner alone.

The image forming apparatus 100 further includes an intermediate transfer belt 15 and first-transfer units 10. In the first-transfer unit 10, the toner images formed by the respective image forming units 200 are to be transferred to the intermediate transfer belt 15.

The image forming apparatus 100 further includes a second-transfer unit 20, in which the toner images transferred to the intermediate transfer belt 15 are to be transferred to a sheet P.

The image forming apparatus 100 further includes a fixing device 60, in which the toner images transferred to the sheet P are to be fixed thereon.

The image forming apparatus 100 further includes a controller 40, which includes a central processing unit (CPU) configured to execute programs to control relevant elements included in the image forming apparatus 100.

The image forming apparatus 100 further includes a user interface (UI) 45, which includes a display panel or the like and is configured to receive instructions from the user and to provide relevant information to the user.

The image forming units 200 include respective developing devices 14. The image forming units 200 further include respective developer refilling devices 70, which are configured to refill the respective developing devices 14 with the respective developers.

The developing devices 14 are configured to visualize, by using the respective toners, electrostatic latent images that are formed on the respective photoconductor drums 11. In other words, the developing devices 14 perform development on the respective photoconductor drums 11 serving as image carriers, and thus form images composed of the respective toners on the photoconductor drums 11.

The developer refilling devices 70 are configured to refill the developing devices 14 with the developers. As described above, the developers are each composed of a carrier and a toner, and the developer refilling devices 70 each refill the corresponding developing device 14 with the carrier and the toner that compose the corresponding developer. In the present exemplary embodiment, the carrier has positive charging polarity, whereas the toner has negative charge polarity.

In each image forming unit 200, the photoconductor drum 11 serving as an exemplary image carrier rotates in the direction of arrow A.

Each image forming unit 200 further includes a charging device 12, which is configured to charge the photoconductor drum 11; and a laser exposure device 13, which is an exemplary exposure device and is configured to form an electrostatic latent image on the photoconductor drum 11. Referring to FIG. 1, the laser exposure device 13 emits an exposure beam Bm. As an alternative exposure device, a device including another light source such as a light-emitting diode (LED) may be employed.

In correspondence with the image forming units 200, first-transfer rolls 16 are provided to transfer the toner images formed on the photoconductor drums 11 to the intermediate transfer belt 15 in the respective first-transfer units 10. Each image forming unit 200 further includes a drum cleaner 17, which is configured to remove developer particles remaining on the photoconductor drum 11.

The intermediate transfer belt 15 is to be rotated at a predetermined speed in the direction of arrow B given in FIG. 1 by a driving roll 31, which is to be driven by a motor (not illustrated).

The first-transfer rolls 16 included in the first-transfer units 10 are located across the intermediate transfer belt 15 from the respective photoconductor drums 11. The toner images formed on the respective photoconductor drums 11 are sequentially attracted to the intermediate transfer belt 15 with an electrostatic force, thereby being superposed one on top of another to form an integrated toner image (hereinafter also simply referred to as “toner image”) on the intermediate transfer belt 15.

The second-transfer unit 20 is an exemplary transfer unit and includes a second-transfer roll 22, which is positioned facing the outer surface of the intermediate transfer belt 15; and a backup roll 25, which is positioned facing the inner surface of the intermediate transfer belt 15.

In the present exemplary embodiment, the integrated toner image composed of the toner images formed by the image forming units 200 and transferred to the intermediate transfer belt 15 is transferred by the second-transfer unit 20 to a sheet P transported to the second-transfer unit 20.

In the present exemplary embodiment, a reversing mechanism 900 is provided to reverse the sheet P.

The reversing mechanism 900 turns over the sheet P having the toner image transferred to one side thereof in the second-transfer unit 20, and supplies the sheet P to the second-transfer unit 20 again.

Hence, in the present exemplary embodiment, the formation of a toner image is performable on both sides of the sheet P.

Specifically, the reversing mechanism 900 according to the present exemplary embodiment includes a branch path R2, which branches off from a sheet transport path R1 and into which the sheet P exited from the fixing device 60 and is to be turned over is sent. More specifically, in the reversing mechanism 900, after the sheet P passes through a branch point BP, the sheet P is transported backward and is sent into the branch path R2.

The branch path R2 meets the sheet transport path R1 at a position upstream of the second-transfer unit 20. Therefore, in the present exemplary embodiment, the sheet P that has been turned over is supplied to the second-transfer unit 20 again. In such a case, the formation of a toner image is performed not only on one side of the sheet P but also on the other side of the sheet P; that is, toner images are formed on both sides of the sheet P.

The entire flow of operations to be performed by the image forming apparatus 100 is as follows.

The image forming apparatus 100 receives image data from, for example, an image reading device or a computer (not illustrated). The received image data is processed. Thus, pieces of image data for the respective image forming units 200 are generated.

For example, the following pieces of image data are generated: pieces of image data to be used in forming images from the developers having the basic colors of yellow, magenta, cyan, and black; and pieces of image data to be used in forming images from the developers having nonbasic colors. The pieces of image data thus generated are outputted to the respective laser exposure devices 13 included in the respective image forming units 200.

In accordance with the pieces of image data received, the laser exposure devices 13 apply to the photoconductor drums 11 respective exposure beams Bm emitted from, for example, respective semiconductor lasers.

In the present exemplary embodiment, the charging devices 12 charge the surfaces of the respective photoconductor drums 11, and then the laser exposure devices 13 perform scan exposure on the respective charged surfaces. Thus, electrostatic latent images are formed on the surfaces of the respective photoconductor drums 11.

Subsequently, the developing devices 14 perform development, whereby toner images are formed on the respective photoconductor drums 11. The toner images are then transferred to the intermediate transfer belt 15 by the respective first-transfer units 10 to be integrated.

With the rotation of the intermediate transfer belt 15, the integrated toner image on the intermediate transfer belt 15 moves to the second-transfer unit 20. Meanwhile, transporting rolls 52 and other relevant elements transport a sheet P from a first sheet container 53 or a second sheet container 54 to the second-transfer unit 20.

Then, the toner image on the intermediate transfer belt 15 is electrostatically transferred to the sheet P in the second-transfer unit 20.

The sheet P thus having the toner image transferred thereto is released from the intermediate transfer belt 15 and is received by a transporting belt 55. The transporting belt 55 transports the sheet P to the fixing device 60.

The sheet P received by the fixing device 60 is heated and pressed by the fixing device 60. Thus, the toner image is fixed on the sheet P. Eventually, the sheet P is discharged from the image forming apparatus 100.

If another toner image is to be formed on the other side of the sheet P, the sheet P exited from the fixing device 60 is sent into the branch path R2 and is supplied to the second-transfer unit 20 again.

In the second-transfer unit 20, another toner image is transferred to the other side of the sheet P. Then, the sheet P passes through the fixing device 60 again, whereby the toner image transferred to the other side of the sheet P is also fixed.

The developing device 14 will now be described.

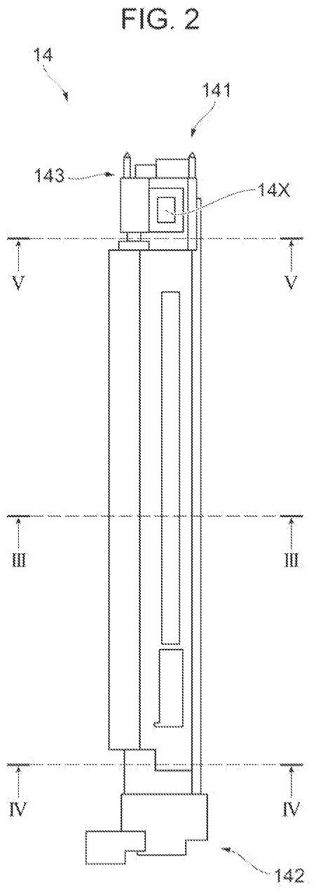

FIG. 2 is a top view of the developing device 14.

The developing device 14 is set in the image forming apparatus 100 in such a manner as to extend in the depthwise direction of the image forming apparatus 100. The developing device 14 has a first end 141 and a second end 142, which are at different positions in the longitudinal direction.

In the present exemplary embodiment, when the developing device 14 is set in the image forming apparatus 100, the first end 141 is positioned on the rear side of the image forming apparatus 100, whereas the second end 142 is positioned on the front side of the image forming apparatus 100.

The developing device 14 includes at the first end 141 thereof a driving-force receiver 143, which is configured to receive a driving force.

In the present exemplary embodiment, the driving-force receiver 143 receives a driving force transmitted from a drive source, such as a motor, provided in the body of the image forming apparatus 100. In the present exemplary embodiment, the driving-force receiver 143 further receives a driving force transmitted from a rotating jig, which will be described separately below.

The driving-force receiver 143 is linked to transporting members and other relevant elements (to be described below) included in the developing device 14. In the present exemplary embodiment, when the driving force of the drive source such as a motor or the driving force of the rotating jig is transmitted to the driving-force receiver 143, the transporting members and other relevant elements rotate.

As to be described below, in the present exemplary embodiment, the members that rotate by receiving the driving force of the drive source such as a motor or the driving force of the rotating jig are the following four members: an upper transporting member; a lower transporting member; a supplying member; and a drum-side transporting member. The driving-force receiver 143 may be provided for each of the four members. In that case, the four driving-force receivers 143 may individually receive the driving force from the drive source such as a motor or from the rotating jig.

Such driving-force receivers 143 to be provided may be fewer than the above four members; that is, a configuration with a single driving-force receiver 143 is also acceptable. Furthermore, the developing device 14 may include a transmitting mechanism (not illustrated) through which the driving force of the drive source such as a motor or of the rotating jig that is received by the driving-force receiver 143 is transmitted to the four members.

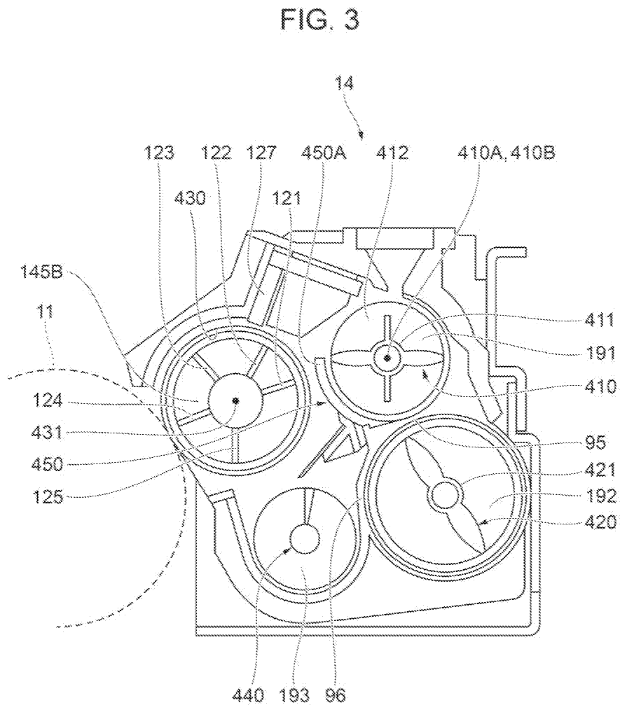

FIG. 3 is a sectional view of the developing device 14, taken along line III-III given in FIG. 2. The section illustrated in FIG. 3 is taken in a longitudinally central part of the developing device 14.

In the developing device 14, an upper movement path 191 is provided for the developer to move in a first direction. Furthermore, in the developing device 14, a lower movement path 192 is provided for the developer to move in a second direction, which is opposite to the first direction. The lower movement path 192 is located lower than the upper movement path 191.

In the upper movement path 191, the developer moves toward the far side in a direction perpendicular to the plane of the page in FIG. 3. In the lower movement path 192, the developer moves toward the near side in the direction perpendicular to the plane of the page in FIG. 3.

The upper movement path 191 is provided with an upper transporting member 410. In the present exemplary embodiment, when the upper transporting member 410 rotates about a rotation shaft 411, extending along the upper movement path 191, the developer moves toward the far side.

Specifically, when the upper transporting member 410 rotates by receiving the driving force transmitted thereto through the driving-force receiver 143 (see FIG. 2) described above, the developer moves toward the far side.

On the other hand, the lower movement path 192 is provided with a lower transporting member 420. In the present exemplary embodiment, when the lower transporting member 420 rotates about a rotation shaft 421, extending along the lower movement path 192, the developer moves toward the near side.

Specifically, when the lower transporting member 420 rotates by receiving the driving force transmitted thereto through the driving-force receiver 143 described above, the developer moves toward the near side.

To the left of the upper movement path 191, a supplying member 430 is provided to receive the developer from the upper movement path 191 and to supply the received developer to the photoconductor drum 11 serving as an image carrier.

The supplying member 430 is a circular cylindrical member. The supplying member 430 is made of, for example, metal such as stainless used steel (SUS).

When the supplying member 430 receives the driving force transmit thereto through the driving-force receiver 143, the supplying member 430 rotates counterclockwise in FIG. 3, thereby moving the developer received from the upper movement path 191 and adhered to the outer peripheral surface of the supplying member 430 to the photoconductor drum 11, which is positioned facing the supplying member 430.

Thus, the developer is supplied to the photoconductor drum 11, and the toner contained in the developer adheres to the surface of the photoconductor drum 11.

The supplying member 430 is positioned such that the axial center, 431, thereof is located lower than the axial center, 410A, of the upper movement path 191.

In the present exemplary embodiment, the supplying member 430 and the upper transporting member 410 are arranged such that the axial center 431 of the supplying member 430 is located lower than the axial center, 410B, of the upper transporting member 410.

Furthermore, in the present exemplary embodiment, the supplying member 430 and the upper transporting member 410 are arranged such that the axial center 431 of the supplying member 430 is located lower than the rotation shaft 411 of the upper transporting member 410.

In the present exemplary embodiment, a stopper 450 is provided between the supplying member 430 and the upper movement path 191 and stops the movement of some of the developer coming from the upper movement path 191 toward the supplying member 430.

In the present exemplary embodiment, some of the developer in the upper movement path 191 that goes over the stopper 450 is supplied to the supplying member 430.

In the present exemplary embodiment, a drum-side transporting member 440 is provided at a position closer to the photoconductor drum 11 than the lower transporting member 420. The drum-side transporting member 440 is located below the supplying member 430 and is configured to transport, toward the far side in the direction perpendicular to the plane of the page in FIG. 3, the developer released from the supplying member 430.

More specifically, when the drum-side transporting member 440 receives the driving force transmitted thereto through the driving-force receiver 143, the drum-side transporting member 440 rotates, thereby transporting the developer released from the supplying member 430 toward the far side in the direction perpendicular to the plane of the page in FIG. 3.

The drum-side transporting member 440 is provided in a drum-side movement path 193, which is located closer to the photoconductor drum 11 than the lower movement path 192. The drum-side movement path 193 extends in the direction perpendicular to the plane of the page in FIG. 3 and is located below the supplying member 430.

In the present exemplary embodiment, the developer released from the supplying member 430 moves along the drum-side movement path 193.

In the present exemplary embodiment, a partition 95 is provided between the upper movement path 191 and the lower movement path 192 and stops the movement of the developer between the upper movement path 191 and the lower movement path 192.

Furthermore, in the present exemplary embodiment, a partition 96 is provided between the drum-side movement path 193 and the lower movement path 192 and stops the movement of the developer between the drum-side movement path 193 and the lower movement path 192.

In the present exemplary embodiment, a magnetic roll 145B is provided inside the supplying member 430.

The magnetic roll 145B includes five magnetic poles 121 to 125, which are arranged side by side in the peripheral direction of the magnetic roll 145B.

The magnetic pole 121 serves as a pick-up pole and attracts the developer supplied from the upper movement path 191. Thus, the developer adheres to the surface of the supplying member 430.

The magnetic poles 122 to 124 serve as transporting poles and transport the developer on the surface of the supplying member 430 toward the downstream side in the direction of rotation of the supplying member 430.

At a position downstream of the magnetic pole 122 but upstream of the magnetic pole 123 in the direction of rotation of the supplying member 430, a layer regulator 127 is provided facing the outer peripheral surface of the supplying member 430. The layer regulator 127 faces the supplying member 430 with a gap in between.

The layer regulator 127 stops the movement of some of the developer adhered to the surface of the supplying member 430, thereby regulating the thickness of the developer on the surface of the supplying member 430 to a predetermined thickness.

While the developer on the surface of the supplying member 430 is moving toward the downstream side in the direction of rotation of the supplying member 430, the developer moves to the surface of the photoconductor drum 11 serving as an exemplary image carrier, whereby the toner contained in the developer adheres to the photoconductor drum 11.

This is how development is performed, in which an image composed of the toner is formed on the surface of the photoconductor drum 11.

The image thus obtained is temporarily carried by the photoconductor drum 11 until the image reaches the first-transfer unit 10 (see FIG. 1) with the rotation of the photoconductor drum 11. Then, the image is transferred to the intermediate transfer belt 15.

The magnetic pole 125 serves as a pick-off pole and generates a repelling magnetic field with which the developer on the surface of the supplying member 430 is released from the supplying member 430. The magnetic pole 125 causes some developer having failed to be transferred to the photoconductor drum 11 and remaining on the surface of the supplying member 430 to be released from the supplying member 430.

The developer thus released from the supplying member 430 drops into the drum-side movement path 193. The developer thus reached the drum-side movement path 193 is transported by the drum-side transporting member 440 toward the first end 141 (see FIG. 2) of the developing device 14, and then moves into the lower movement path 192 (see FIG. 3) (details will be described separately below).

The upper transporting member 410 (see FIG. 3), the lower transporting member 420, the supplying member 430, the magnetic roll 145B, and the drum-side transporting member 440 each extend in the direction perpendicular to the plane of the page in FIG. 3 and are parallel to one another.

The upper transporting member 410 including the rotation shaft 411 extending in the longitudinal direction of the developing device 14 further includes a projecting member 412, which projects from the outer peripheral surface of the rotation shaft 411.

The projecting member 412 spirally extends from one axial end to the other axial end of the rotation shaft 411. In other words, the projecting member 412 is in the form of a screw.

In the present exemplary embodiment, when the rotation shaft 411 of the upper transporting member 410 rotates, the projecting member 412 pushes the developer in the axial direction of the rotation shaft 411, whereby the developer moves in the direction in which the rotation shaft 411 extends.

The lower transporting member 420 and the drum-side transporting member 440 have the same configuration as the upper transporting member 410 and include respective rotation shafts extending in the longitudinal direction of the developing device 14 and respective spiral projecting members.

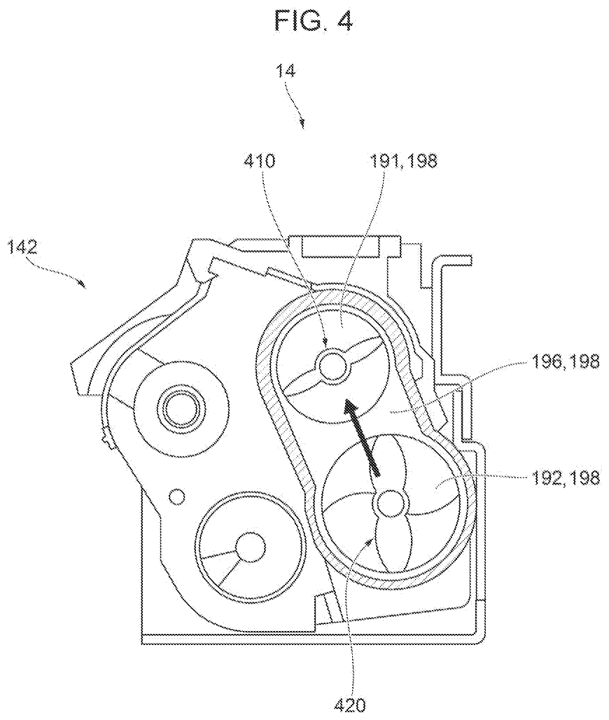

FIG. 4 is a sectional view of the developing device 14, taken along line IV-IV given in FIG. 2.

The section illustrated in FIG. 4 is taken at the second end 142 of the developing device 14.

In the present exemplary embodiment, as illustrated in FIG. 4, the developing device 14 includes at the second end 142 thereof an upward movement path 196, which extends in the top-bottom direction and through which the developer moved along the lower movement path 192 goes into the upper movement path 191.

Herein, the expression “to extend in the top-bottom direction” is not limited to a situation where the upward movement path 196 extends in the vertical direction and encompasses a situation where the upward movement path 196 is inclined relative to the vertical direction.

In the present exemplary embodiment, the developer transported by the lower transporting member 420 and reached the second end 142 of the developing device 14 builds up in a lower part of the upward movement path 196, thereby gradually moving upward in the upward movement path 196.

Thus, the developer is supplied to the upper transporting member 410. The upper transporting member 410 receives the developer coming from the upward movement path 196 and transports the developer along the upper movement path 191 toward the first end 141 (see FIG. 2) of the developing device 14.

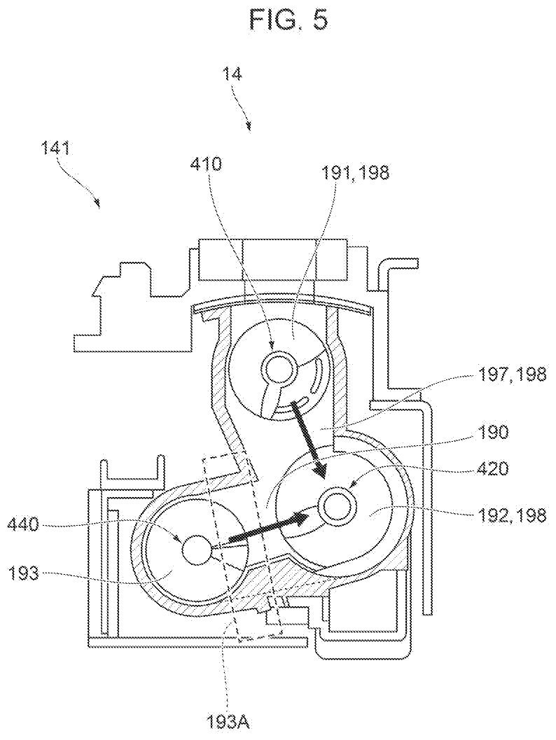

FIG. 5 is a sectional view of the developing device 14, taken along line V-V given in FIG. 2.

The section illustrated in FIG. 5 is taken at the first end 141 of the developing device 14.

In the present exemplary embodiment, as illustrated in FIG. 5, the developing device 14 includes at the first end 141 thereof a downward movement path 197, which extends in the top-bottom direction and through which the developer moved along the upper movement path 191 goes into the lower movement path 192.

As described above, the expression “to extend in the top-bottom direction” is not limited to a situation where the downward movement path 197 extends in the vertical direction and encompasses a situation where the downward movement path 197 is inclined relative to the vertical direction.

In the present exemplary embodiment, the developer moved along the upper movement path 191 passes through the downward movement path 197 to go into the lower movement path 192. Then, the developer moves along the lower movement path 192 toward the second end 142 (see FIG. 2) of the developing device 14.

In the developing device 14 according to the present exemplary embodiment, the four paths of the upper movement path 191, the downward movement path 197, the lower movement path 192, and the upward movement path 196 (see FIG. 4) form a loop-shaped developer movement path 198. In the present exemplary embodiment, the developer circulates along the loop-shaped developer movement path 198.

Furthermore, in the present exemplary embodiment, as illustrated in FIG. 5, a connecting path 190 extends laterally and thus connects the drum-side movement path 193 and the lower movement path 192 to each other.

In the present exemplary embodiment, the developer transported by the drum-side transporting member 440 along the drum-side movement path 193 passes through the connecting path 190 to go into the lower movement path 192.

As described above, the developing device 14 according to the present exemplary embodiment has the loop-shaped developer movement path 198, and the developer circulates along the loop-shaped developer movement path 198, whereby the developer is stirred.

In the present exemplary embodiment, while the developer that is being stirred is moving along the upper movement path 191 (see FIG. 3), some of the developer goes over the stopper 450 and is supplied to the supplying member 430, thereby adhering to the surface of the supplying member 430.

The developer thus adhered to the surface of the supplying member 430 moves with the rotation of the supplying member 430 to the position in front of the photoconductor drum 11 and is supplied to the photoconductor drum 11.

Some developer adhered to the surface of the supplying member 430 but failed to be supplied to the photoconductor drum 11 passes the position across from the magnetic pole 125 serving as a pick-off pole, is released from the supplying member 430, and drops down.

The developer thus dropped down is received by the drum-side movement path 193 provided with the drum-side transporting member 440.

The developer thus reached the drum-side movement path 193 moves along the drum-side movement path 193 and reaches a connection area 193A (see FIG. 5), where the drum-side movement path 193 and the connecting path 190 are connected to each other.

Then, the developer moves along the connecting path 190 into the lower movement path 192. The developer thus reached the lower movement path 192 moves along the loop-shaped developer movement path 198 again.

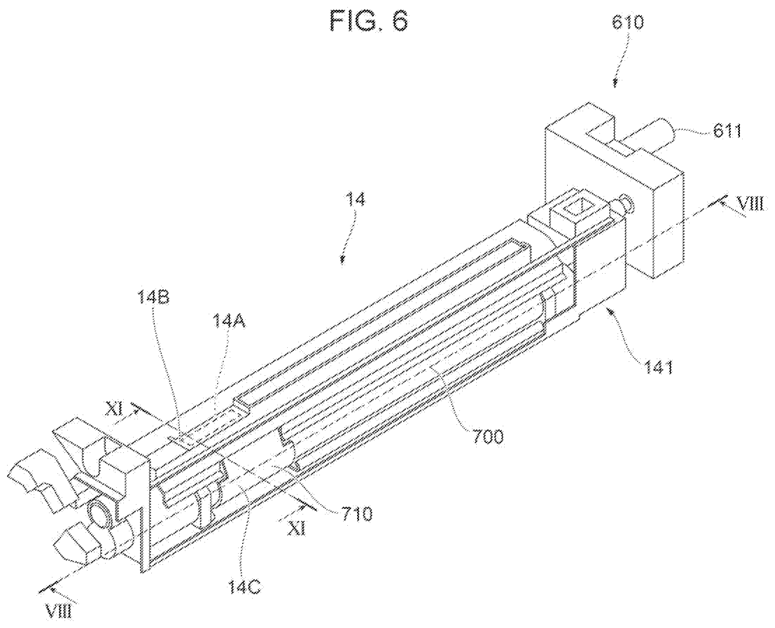

FIG. 6 illustrates the developing device 14 with a rotating jig 610 attached thereto.

In the present exemplary embodiment, when the rotating jig 610 is attached to the first end 141 of the developing device 14, the user is allowed to manually rotate the upper transporting member 410 (not illustrated in FIG. 6), the lower transporting member 420, the supplying member 430, and the drum-side transporting member 440 included in the developing device 14.

More specifically, in the present exemplary embodiment, when the handle, 611, of the rotating jig 610 is rotated by the user, a driving force is transmitted from the rotating jig 610 to the driving-force receiver 143 (see FIG. 2). Accordingly, the upper transporting member 410, the lower transporting member 420, the supplying member 430, and the drum-side transporting member 440 included in the developing device 14 rotate.

In the present exemplary embodiment, manual supply of developer to the developing device 14 is possible if the rotating jig 610 is attached to the first end 141 of the developing device 14.

When the user rotates the handle 611, each of the upper transporting member 410, the lower transporting member 420, the supplying member 430, and the drum-side transporting member 440 rotates.

Some user may want to form an image by using a developer having a nonbasic color. In such a case, in the present exemplary embodiment, the rotating jig 610 is attached to the developing device 14, and the developer having a nonbasic color is manually supplied to the developing device 14.

As yet to be described, referring to FIG. 6, the developing device 14 according to the present exemplary embodiment has at the top thereof an inlet 14A, through which developer is to be manually supplied to the developing device 14. That is, in the present exemplary embodiment, the inlet 14A serves as an inlet for fresh developer to be supplied to the developing device 14.

In FIG. 6, the inlet 14A is covered by an inlet covering member 14B. To supply fresh developer to the developing device 14, the inlet covering member 14B is removed. Thus, the inlet 14A is exposed.

In the present exemplary embodiment, fresh developer to be supplied to the developing device 14 is received at the inlet 14A. In the present exemplary embodiment, the inlet 14A is an opening.

As yet to be described, referring to FIG. 6, the developing device 14 according to the present exemplary embodiment includes a metal pipe 700, which extends in the longitudinal direction of the developing device 14.

In the present exemplary embodiment, the metal pipe 700 is utilized to promote heat radiation from the developing device 14.

In the present exemplary embodiment, the lower movement path 192 (see FIG. 3) is provided inside the pipe 700. In the present exemplary embodiment, the lower transporting member 420 (see FIG. 3) is located inside the pipe 700.

In the present exemplary embodiment, as described with reference to FIG. 3, the partition 95 is provided between the upper movement path 191 and the lower movement path 192 and stops the movement of the developer between the upper movement path 191 and the lower movement path 192. A part of the partition 95 is formed of a part of the pipe 700.

In the present exemplary embodiment, as illustrated in FIG. 6, the pipe 700 has an outlet 710.

In FIG. 6, the outlet 710 is covered by an outlet covering member 14C. Through the outlet 710, the developer is to be discharged from the developing device 14 (details will be described separately below).

In the present exemplary embodiment, the outlet 710 is provided in the peripheral face of the pipe 700 and is connected to the lower movement path 192 (see FIG. 3) provided inside the pipe 700.

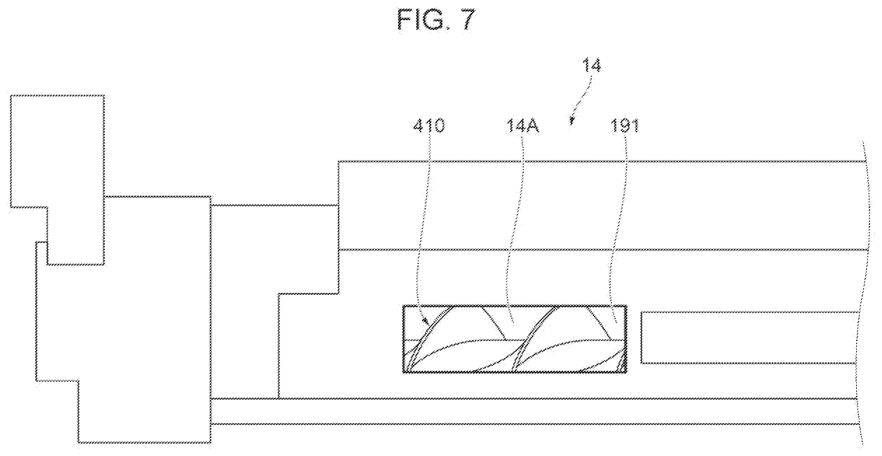

FIG. 7 is a top view of the developing device 14 with the inlet covering member 14B removed therefrom.

Removing the inlet covering member 14B as illustrated in FIG. 7 exposes the inlet 14A through which fresh developer is to be supplied to the developing device 14.

Below the inlet 14A extends the upper transporting member 410 provided in the upper movement path 191.

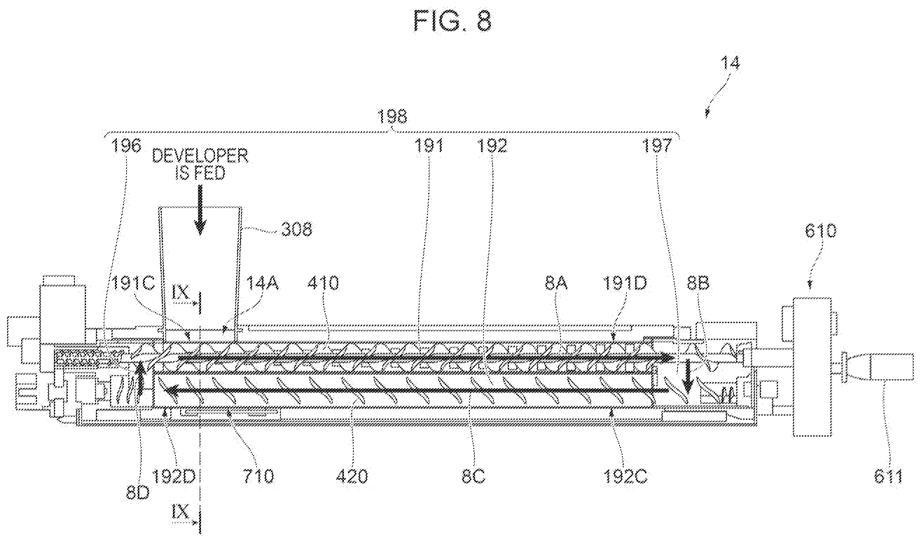

FIG. 8 is a sectional view of the developing device 14, taken along line VIII-VIII given in FIG. 6.

The section illustrated in FIG. 8 lies in a plane passing through both the lower movement path 192 and the upper movement path 191.

In the present exemplary embodiment, as illustrated in FIG. 8 and as described above, the upper movement path 191, the downward movement path 197, the lower movement path 192, and the upward movement path 196 form the loop-shaped developer movement path 198.

The directions of movement of the developer in the upper movement path 191, in the downward movement path 197, in the lower movement path 192, and in the upward movement path 196 are represented by respective arrows 8A, 8B, 8C, and 8D.

In the present exemplary embodiment, to manually supply fresh developer to the developing device 14, as illustrated in FIG. 8, a funnel-shaped guiding member 308 is set at the inlet 14A from above.

Fresh developer to be manually supplied to the developing device 14 is fed into the guiding member 308. The developer thus fed passes through the inlet 14A and first goes into the upper movement path 191 of the developing device 14.

After the developer is fed into the guiding member 308, the user rotates the handle 611, whereby the upper transporting member 410, the lower transporting member 420, the supplying member 430 (not illustrated in FIG. 8), and the drum-side transporting member 440 (not illustrated in FIG. 8) are rotated.

Accordingly, the developer in the upper movement path 191 moves to the lower movement path 192 and to the supplying member 430 and the drum-side movement path 193.

More specifically, the developer fed through the inlet 14A into the upper movement path 191 moves along the upper movement path 191 as represented by arrow 8A in FIG. 8 toward the downward movement path 197.

Then, as represented by arrow 8B, the developer moves along the downward movement path 197 toward the lower movement path 192. Furthermore, as represented by arrow 8C, the developer moves along the lower movement path 192 toward the upward movement path 196.

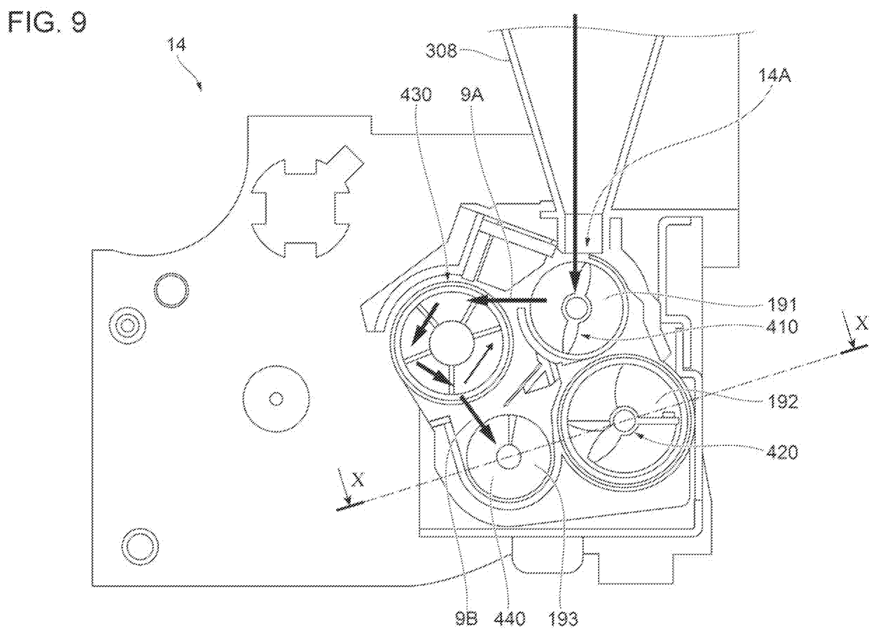

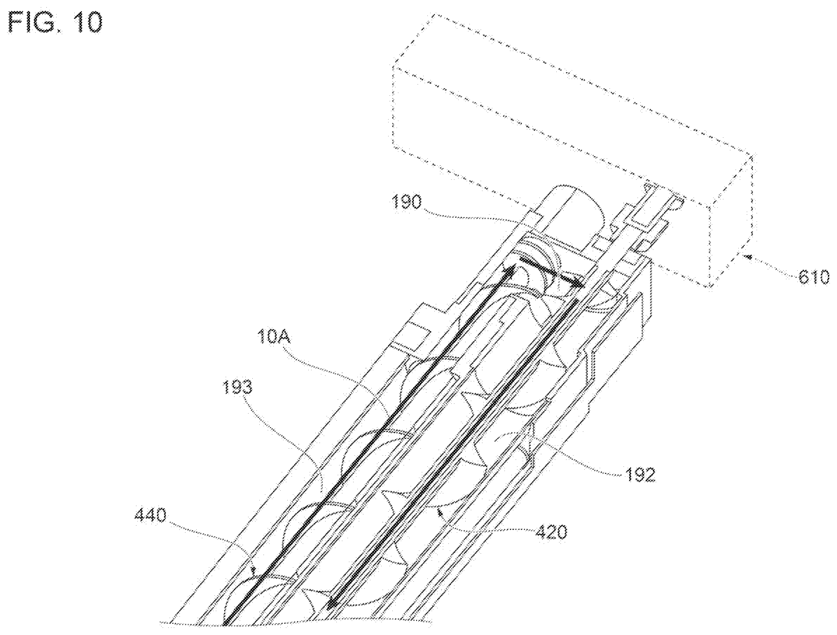

FIG. 9 is a sectional view of the developing device 14, taken along line IX-IX given in FIG. 8. FIG. 10 is a sectional view of the developing device 14, taken along line X-X given in FIG. 9.

In the present exemplary embodiment, as illustrated in FIG. 9, while the developer fed through the inlet 14A into the upper movement path 191 is moving along the upper movement path 191 toward the downstream side, some of the developer in the upper movement path 191 moves toward the supplying member 430 as represented by arrow 9A. Thus, the developer is supplied to the surface of the supplying member 430.

Then, in the present exemplary embodiment, as represented by arrow 9B, the developer received by the supplying member 430 is supplied to the drum-side transporting member 440.

In the area where the drum-side transporting member 440 is located, as represented by arrow 10A in FIG. 10, the drum-side transporting member 440 transports the developer to the connecting path 190. The developer thus reached the connecting path 190 advances through the connecting path 190 to the lower movement path 192.

To summarize, in the present exemplary embodiment, when the user rotates the handle 611, fresh developer is supplied to the upper transporting member 410, the lower transporting member 420, the supplying member 430, and the drum-side transporting member 440 included in the developing device 14.

In other words, in the present exemplary embodiment, when the user rotates the handle 611, fresh developer is supplied to the upper movement path 191, the lower movement path 192, the supplying member 430, and the drum-side movement path 193 provided in the developing device 14.

In the present exemplary embodiment, the developer received at the inlet 14A (see FIG. 8) is first supplied to the upper movement path 191. Then, the developer moves along the upper movement path 191 before moving to the lower movement path 192.

Meanwhile, as illustrated in FIG. 9, some of the developer supplied to the upper movement path 191 moves to the supplying member 430 and then to the drum-side movement path 193.

In the case where developer is manually fed into the developing device 14, the speeds of rotation of the upper transporting member 410, the lower transporting member 420, the supplying member 430, and the drum-side transporting member 440 tend to be lower than in the case where developer is fed into the developing device 14 by using the drive source such as a motor.

In the case of manual feeding, if the developer received at the inlet 14A is first supplied to the lower movement path 192, for example, the developer having moved along the lower movement path 192 and reached the upward movement path 196 may fail to move upward. That is, the developer may fail to be supplied to the upper movement path 191.

If the developer fails to be supplied to the upper movement path 191, no developer is supplied to the supplying member 430 and the drum-side movement path 193.

In such a situation, the amount of developer that is allowed to pass through the inlet 14A is reduced; that is, the amount of developer to be fed into the developing device 14 is reduced.

In contrast, in the present exemplary embodiment, the developer is first supplied to the upper movement path 191 and is then supplied to the lower movement path 192. Meanwhile, some of the developer in the upper movement path 191 is supplied to the supplying member 430 and then to the drum-side movement path 193.

In such a configuration, an increased amount of developer is allowed to pass through the inlet 14A, and an increased amount of developer is fed into the developing device 14.

In the present exemplary embodiment, as illustrated in FIG. 8, the developer received at the inlet 14A is supplied to a part of the upper movement path 191 that is located on the upstream side in the direction of developer movement, specifically an upstream part 191C.

In other words, the developer received at the inlet 14A is supplied to the upstream part 191C of the upper movement path 191 that is located on the upstream side relative to a longitudinally central part of the upper movement path 191.

The developer supplied to the upstream part 191C then moves to a part of the upper movement path 191 that is located on the downstream side in the direction of developer movement, specifically a downstream part 191D. Then, the developer moves to the lower movement path 192.

The upstream part 191C is located close to the upward movement path 196. The downstream part 191D is located close to the downward movement path 197.

The developer received at the inlet 14A is first supplied to the upstream part 191C of the upper movement path 191 that is located close to the upward movement path 196. Then, the developer moves to the downstream part 191D of the upper movement path 191 that is located closed to the downward movement path 197, and further moves to the lower movement path 192.

If the developer received at the inlet 14A is first supplied to the downstream part 191D, the developer may fail to reach the upstream part 191C of the upper movement path 191, leaving in the upstream part 191C an unsupplied region where no developer is supplied.

In the present exemplary embodiment, as illustrated in FIG. 8, the outlet 710 is provided in such a manner as to be connected to the lower movement path 192 at a position close to the upward movement path 196.

The lower movement path 192 includes an upstream part 192C, which is located close to the downward movement path 197; and a downstream part 192D, which is located close to the upward movement path 196.

The outlet 710 is connected to the downstream part 192D of the lower movement path 192 that is located close to the upward movement path 196.

Suppose that the outlet 710 is connected to the upstream part 192C of the lower movement path 192 that is located close to the downward movement path 197.

In such a configuration, some developer in an area of the lower movement path 192 that is between the connection to the outlet 710 and the connection to the upward movement path 196 may fail to be discharged and remain in the lower movement path 192.

Moreover, in the case where the user manually rotates the handle 611, since the speed of rotation of the lower transporting member 420 tends to be low, the developer transported by the lower transporting member 420 and reached the upward movement path 196 may fail to move upward.

In such a situation, some developer in an area of the lower movement path 192 that is between the connection to the outlet 710 and the connection to the upward movement path 196 may fail to be discharged and remain in the lower movement path 192.

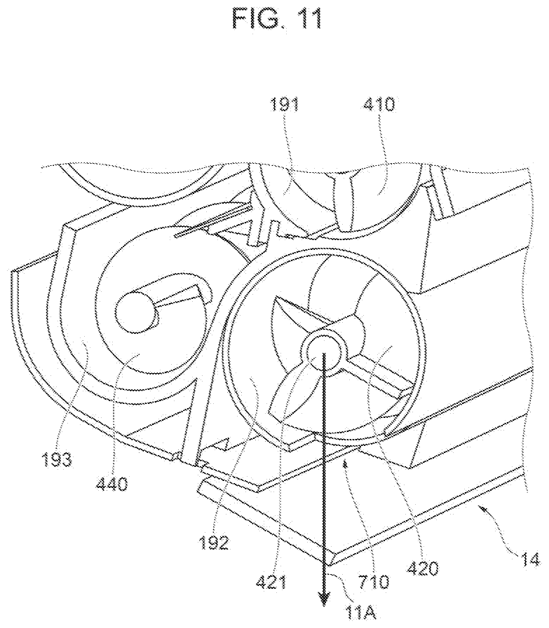

FIG. 11 is a sectional view of the developing device 14, taken along line XI-XI given in FIG. 6.

In FIG. 11, the outlet covering member 14C illustrated in FIG. 6 is not illustrated.

In the present exemplary embodiment, as illustrated in FIG. 11, the outlet 710 is located lower than the lower movement path 192.

The outlet 710 is oriented to face obliquely downward. The outlet 710 is oriented in a direction different from the direction of a vertical line 11A, which extends downward from the rotation shaft 421 of the lower transporting member 420.

In the present exemplary embodiment, as described above, the outlet 710 is located below the downstream part 192D (see FIG. 8) of the lower movement path 192 that is located on the downstream side in the direction of developer movement.

While the present exemplary embodiment relates to a configuration in which the outlet 710 is located immediately below the lower movement path 192 as illustrated in FIG. 11, the outlet 710 may alternatively be located away from the lower movement path 192. In the latter configuration, a path is provided that connects the lower movement path 192 and the outlet 710 to each other.

Even such an outlet 710 located away from the lower movement path 192 is to be connected to the downstream part 192D of the lower movement path 192 that is located on the downstream side in the direction of developer movement.

Furthermore, even such an outlet 710 located away from the lower movement path 192 is to be located lower than the lower movement path 192. More specifically, the outlet 710 is to be located lower than the lower movement path 192 in terms of vertical position.

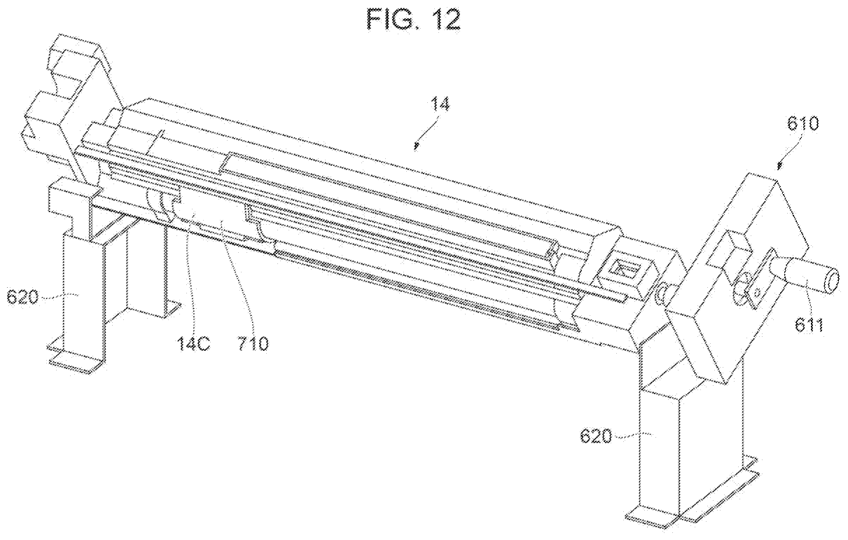

FIG. 12 illustrates the developing device 14 mounted on a discharging jig 620.

In the present exemplary embodiment, the developer is manually dischargeable from the developing device 14.

To discharge the developer from the developing device 14, as illustrated in FIG. 12, the developing device 14 is mounted on the discharging jig 620, which is to be used in discharging the developer.

When the developing device 14 is mounted on the discharging jig 620, the orientation of the developing device 14 changes such that the outlet 710 faces vertically downward.

In the present exemplary embodiment, after the developing device 14 is mounted on the discharging jig 620, the outlet covering member 14C is removed. Then, the handle 611 is rotated. Thus, the developer in the developing device 14 is discharged through the outlet 710.

The developer discharged through the outlet 710 is to be received by a pan (not illustrated) placed below the outlet 710.

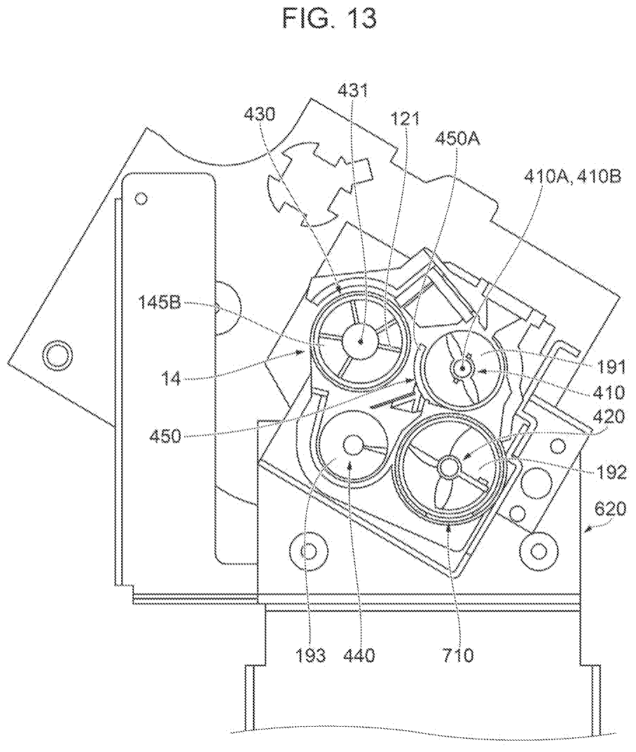

FIG. 13 is a sectional view of the developing device 14 mounted on the discharging jig 620.

In the present exemplary embodiment, when the developing device 14 is mounted on the discharging jig 620, as illustrated in FIG. 13, the outlet 710 is oriented to face vertically downward. That is, in the present exemplary embodiment, when the developing device 14 is mounted on the discharging jig 620, the orientation of the developing device 14 changes such that the outlet 710 faces vertically downward.

In this state, the handle 611 (see FIG. 12) is rotated by the user, whereby the upper transporting member 410, the lower transporting member 420, the supplying member 430, and the drum-side transporting member 440 are rotated.

Accordingly, the developer in the lower movement path 192 is transported toward the outlet 710.

Meanwhile, the developer in the upper movement path 191 is transported through the downward movement path 197 (not illustrated in FIG. 13) and lower movement path 192 toward the outlet 710.

Furthermore, the developer in the drum-side movement path 193 is transported through the connecting path 190 (not illustrated in FIG. 13) and the lower movement path 192 toward the outlet 710.

Furthermore, the developer adhered to the surface of the supplying member 430 is transported through the drum-side movement path 193, the connecting path 190 (not illustrated in FIG. 13), and the lower movement path 192 toward the outlet 710.

In the present exemplary embodiment, when the developing device 14 is mounted on the discharging jig 620, as illustrated in FIG. 13, the axial center 431 of the supplying member 430 is shifted to a position higher than the axial center 410A of the upper movement path 191.

That is, in the present exemplary embodiment, when the orientation of the developing device 14 is changed such that the outlet 710 faces vertically downward, the axial center 431 of the supplying member 430 is shifted in the vertical direction to a position higher than the axial center 410A of the upper movement path 191.

In other words, in the present exemplary embodiment, the axial center 431 of the supplying member 430 is shifted to a position higher than the axial center 410B of the upper transporting member 410.

In the orientation illustrated in FIG. 3, the axial center 431 of the supplying member 430 is located lower than the axial center 410A of the upper movement path 191. In contrast, in the orientation illustrated in FIG. 13, the axial center 431 of the supplying member 430 is located higher than the axial center 410A of the upper movement path 191.

Therefore, the developer is less likely to move from the upper movement path 191 toward the supplying member 430.

Furthermore, in the present exemplary embodiment, when the orientation of the developing device 14 is changed such that the outlet 710 faces vertically downward as illustrated in FIG. 13, the upper end, 450A, of the stopper 450 is shifted to a position higher than in the orientation illustrated in FIG. 3.

Therefore, the developer is much less likely to move from the upper movement path 191 toward the supplying member 430.

The developer adhered to the surface of the supplying member 430 is attracted thereto by the magnetic pole 121 and the like included in the magnetic roll 145B and is therefore less likely to drop from the surface of the supplying member 430. That is, the developer adhered to the surface of the supplying member 430 is difficult to discharge from the developing device 14.

If the developer in the upper movement path 191 easily moves to the supplying member 430 while the developer is being discharged through the outlet 710, such developer that has moved to the supplying member 430 stays on the surface of the supplying member 430 and is not discharged easily.

Furthermore, such developer that has moved from the upper movement path 191 to the supplying member 430 is supposed to move by a long distance along the drum-side movement path 193, the connecting path 190 (not illustrated in FIG. 13), and the lower movement path 192 before reaching the outlet 710, taking a long time to be discharged.

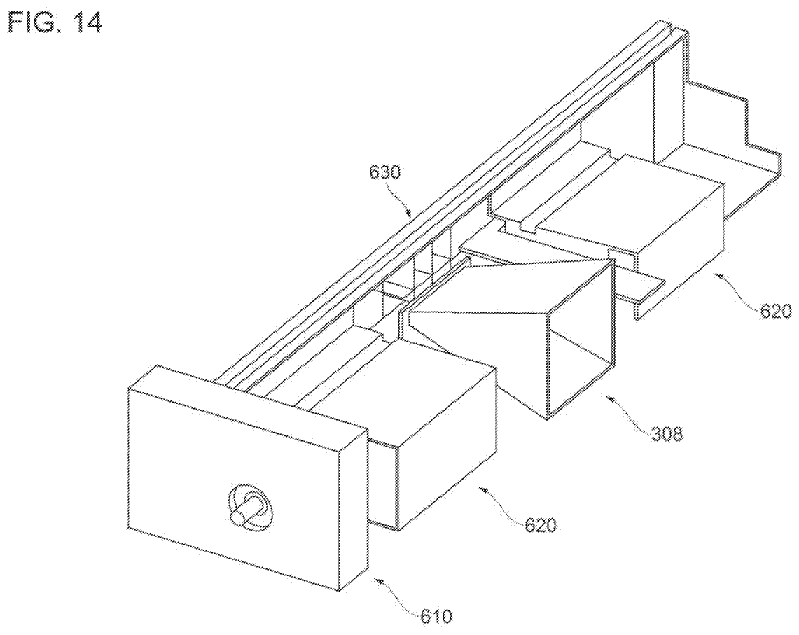

FIG. 14 illustrates a set of relevant elements including the jigs.

The present exemplary embodiment employs a supporting member 630, which supports the guiding member 308, the rotating jig 610, and the discharging jig 620 that have been described above. In the present exemplary embodiment, the guiding member 308, the rotating jig 610, and the discharging jig 620 are attached to the supporting member 630 and are thus integrated together.

In other words, in the present exemplary embodiment, attaching the guiding member 308, the rotating jig 610, and the discharging jig 620 to the supporting member 630 provides a single assembly including the guiding member 308, the rotating jig 610, and the discharging jig 620.

In the present exemplary embodiment, the assembly is housed in a housing area (not illustrated) provided in the image forming apparatus 100 (see FIG. 1).

To feed developer into the developing device 14 or to discharge the developer from the developing device 14, the assembly is taken out of the housing area.

Then, feeding of developer into the developing device 14 or discharge of the developer from the developing device 14 is performed by using any of the guiding member 308, the rotating jig 610, and the discharging jig 620 included in the assembly.

Referring to FIG. 2, the developing device 14 according to the present exemplary embodiment will further be described.

As illustrated in FIG. 2, the developing device 14 according to the present exemplary embodiment has at the first end 141 thereof a second inlet 14X, through which fresh developer is to be supplied to the developing device 14.

In the present exemplary embodiment, the developer to be supplied from the developer refilling device 70 (see FIG. 1) is received at the second inlet 14X.

In the present exemplary embodiment, in the state where the developing device 14 is set in the image forming apparatus 100, the driving of the upper transporting member 410, the lower transporting member 420, the supplying member 430, and the drum-side transporting member 440 included in the developing device 14 is not performed manually but is performed by the drive source provided in the body of the image forming apparatus 100.

Furthermore, in the present exemplary embodiment, when the developer in the developer refilling device 70 is supplied to the developing device 14 that is set in the image forming apparatus 100, the developer is received at the second inlet 14X.

More specifically, for example, the developing device 14 for any of the basic colors receives the supply of the corresponding developer from the corresponding developer refilling device 70 through the second inlet 14X.

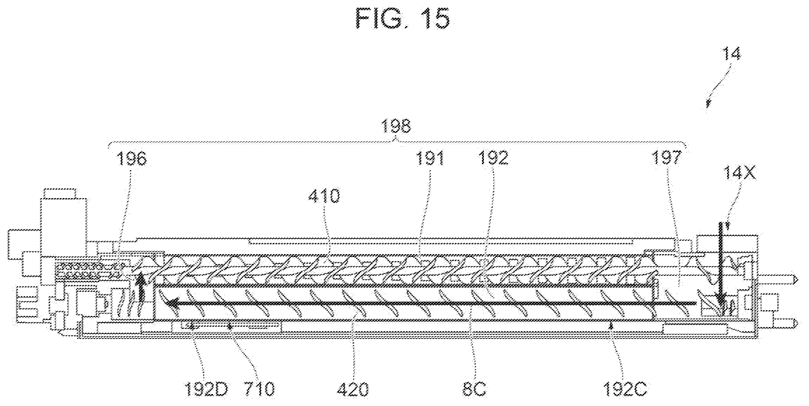

FIG. 15 illustrates the movement of the developer supplied through the second inlet 14X to the developing device 14.

As illustrated in FIG. 15, the developer received at the second inlet 14X does not pass through the upper movement path 191 but is supplied to the lower movement path 192 and then moves along the lower movement path 192 to the upper movement path 191.

Specifically, the developer fed into the developing device 14 through the second inlet 14X moves downward to be first supplied to the lower movement path 192. Then, the developer moves along the lower movement path 192 to the upper movement path 191.

The developer fed through the second inlet 14X into the lower movement path 192 is first received at the upstream part 192C of the lower movement path 192.

Subsequently, the developer moves through the downstream part 192D of the lower movement path 192 and reaches the upward movement path 196. Furthermore, the developer moves through the upward movement path 196 into the upper movement path 191. Then, the developer moves along the upper movement path 191 toward the downstream side.

While the developer is moving along the upper movement path 191 toward the downstream side, some of the developer is supplied from the upper movement path 191 to the supplying member 430 (not illustrated in FIG. 15) and is further supplied from the supplying member 430 to the drum-side movement path 193 (not illustrated in FIG. 15).

When developer is supplied through the second inlet 14X to the developing device 14, as described above, the drive source provided in the body of the image forming apparatus 100 is used to drive the upper transporting member 410, the lower transporting member 420, the supplying member 430, and the drum-side transporting member 440 included in the developing device 14.

When the drive source provided in the body of the image forming apparatus 100 is used, the lower transporting member 420 is rotated at a speed high enough to cause the developer to move from the lower movement path 192 through the upward movement path 196 into the upper movement path 191.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A developing device configured to perform development on an image carrier, the developing device comprising:
a loop-shaped developer movement path in which developer is to circulate, the developer movement path including an upper movement path and a lower movement path along each of which the developer is to move, the lower movement path being located lower than the upper movement path; and
an inlet through which fresh developer is to be supplied to the developing device.
wherein the developer received at the inlet is caused to move along the upper movement path before moving to the lower movement path.
   (((2)))

The developing device according to (((1))),
wherein the developer received at the inlet is supplied to a first part of the upper movement path and then moves through a second part of the upper movement path into the lower movement path, the first part being located on an upstream side of the upper movement path in a direction of developer movement, the second part being located on a downstream side of the upper movement path in the direction of developer movement.
   (((3)))

The developing device according to (((1))),
wherein the loop-shaped developer movement path further includes:
   an upward movement path extending in a top-bottom direction and through which the developer moved along the lower movement path goes into the upper movement path; and
   a downward movement path extending in the top-bottom direction and through which the developer moved along the upper movement path goes into the lower movement path,
wherein the upper movement path includes a part located close to the upward movement path and a part located close to the downward movement path, and
wherein the developer received at the inlet is supplied to the part located close to the upward movement path and then moves through the part located close to the downward movement path into the lower movement path.
   (((4)))

The developing device according to any one of (((1))) to (((3))), further comprising:
an outlet connected to the lower movement path and through which the developer is to be discharged from the developing device,
wherein the loop-shaped developer movement path further includes:
   an upward movement path extending in a top-bottom direction and through which the developer moved along the lower movement path goes into the upper movement path; and
   a downward movement path extending in the top-bottom direction and through which the developer moved along the upper movement path goes into the lower movement path,
wherein the lower movement path includes a part located close to the upward movement path and a part located close to the downward movement path, and
wherein the outlet is connected to the lower movement path at the part located close to the upward movement path.
   (((5)))

The developing device according to any one of (((1))) to (((3))), further comprising:
an outlet through which the developer is to be discharged from the developing device,
wherein the outlet is located lower than the lower movement path.
   (((6)))

The developing device according to (((5))),
wherein the outlet is located below a part of the lower movement path, the part being located on a downstream side of the lower movement path in a direction of developer movement.
   (((7)))

The developing device according to any one of (((1))) to (((6))), further comprising:
a supplying member configured to receive the developer from the upper movement path and to supply the developer to the image carrier; and
a second inlet through which fresh developer is to be supplied to the developing device,
wherein the developer received at the second inlet is supplied to the lower movement path and then moves along the lower movement path before moving to the upper movement path.
   (((8)))

The developing device according to (((7))),
wherein the developer received at the second inlet is supplied to a first part of the lower movement path and then moves through a second part of the lower movement path into the upper movement path, the first part being located on an upstream side of the lower movement path in a direction of developer movement, the second part being located on a downstream side of the lower movement path in the direction of developer movement.
   (((9)))

The developing device according to (((1))), further comprising:
a supplying member configured to receive the developer from the upper movement path and to supply the developer to the image carrier, the supplying member having an axial center located lower than an axial center of the upper movement path; and
an outlet through which the developer is to be discharged from the developing device, the outlet facing obliquely downward,
wherein when an orientation of the developing device is changed such that the outlet faces vertically downward, the axial center of the supplying member is shifted to a position higher than the axial center of the upper movement path.
   (((10)))

The developing device according to (((9))), further comprising:
a stopper provided between the supplying member and the upper movement path and configured to stop movement of some of the developer coming from the upper movement path toward the supplying member,
wherein when the orientation of the developing device is changed such that the outlet faces vertically downward, an upper end of the stopper is shifted upward.
   (((11)))

An image forming apparatus comprising:
an image carrier; and
a developing device configured to form an image on the image carrier by performing development on the image carrier.
wherein the developing device includes the developing device according to any one of (((1))) to (((10))).

What is claimed is:

1. A developing device configured to perform development on an image carrier, the developing device comprising:
a loop-shaped developer movement path in which developer is to circulate, the developer movement path including an upper movement path and a lower movement path along each of which the developer is to move, the lower movement path being located lower than the upper movement path; and
an inlet through which fresh developer is to be supplied to the developing device,
wherein the developer received at the inlet is caused to move along the upper movement path before moving to the lower movement path.

2. The developing device according to claim 1,
wherein the developer received at the inlet is supplied to a first part of the upper movement path and then moves through a second part of the upper movement path into the lower movement path, the first part being located on an upstream side of the upper movement path in a direction of developer movement, the second part being located on a downstream side of the upper movement path in the direction of developer movement.

3. The developing device according to claim 1,
wherein the loop-shaped developer movement path further includes:
an upward movement path extending in a top-bottom direction and through which the developer moved along the lower movement path goes into the upper movement path; and
a downward movement path extending in the top-bottom direction and through which the developer moved along the upper movement path goes into the lower movement path,
wherein the upper movement path includes a part located close to the upward movement path and a part located close to the downward movement path, and
wherein the developer received at the inlet is supplied to the part located close to the upward movement path and then moves through the part located close to the downward movement path into the lower movement path.

4. The developing device according to claim 1, further comprising:
an outlet connected to the lower movement path and through which the developer is to be discharged from the developing device,
wherein the loop-shaped developer movement path further includes:
an upward movement path extending in a top-bottom direction and through which the developer moved along the lower movement path goes into the upper movement path; and
a downward movement path extending in the top-bottom direction and through which the developer moved along the upper movement path goes into the lower movement path,
wherein the lower movement path includes a part located close to the upward movement path and a part located close to the downward movement path, and
wherein the outlet is connected to the lower movement path at the part located close to the upward movement path.

5. The developing device according to claim 1, further comprising:
an outlet through which the developer is to be discharged from the developing device,
wherein the outlet is located lower than the lower movement path.

6. The developing device according to claim 5,
wherein the outlet is located below a part of the lower movement path, the part being located on a downstream side of the lower movement path in a direction of developer movement.

7. The developing device according to claim 1, further comprising:
a supplying member configured to receive the developer from the upper movement path and to supply the developer to the image carrier; and
a second inlet through which fresh developer is to be supplied to the developing device,
wherein the developer received at the second inlet is supplied to the lower movement path and then moves along the lower movement path before moving to the upper movement path.

8. The developing device according to claim 7,
wherein the developer received at the second inlet is supplied to a first part of the lower movement path and then moves through a second part of the lower movement path into the upper movement path, the first part being located on an upstream side of the lower movement path in a direction of developer movement, the second part being located on a downstream side of the lower movement path in the direction of developer movement.

9. The developing device according to claim 1, further comprising:
a supplying member configured to receive the developer from the upper movement path and to supply the developer to the image carrier, the supplying member having an axial center located lower than an axial center of the upper movement path; and
an outlet through which the developer is to be discharged from the developing device, the outlet facing obliquely downward,
wherein when an orientation of the developing device is changed such that the outlet faces vertically downward, the axial center of the supplying member is shifted to a position higher than the axial center of the upper movement path.

10. The developing device according to claim 9, further comprising:
a stopper provided between the supplying member and the upper movement path and configured to stop movement of some of the developer coming from the upper movement path toward the supplying member,
wherein when the orientation of the developing device is changed such that the outlet faces vertically downward, an upper end of the stopper is shifted upward.

11. An image forming apparatus comprising:
an image carrier; and
a developing device configured to form an image on the image carrier by performing development on the image carrier,
wherein the developing device includes the developing device according to claim 1.

12. An image forming apparatus comprising:
an image carrier; and
a developing device configured to form an image on the image carrier by performing development on the image carrier,
wherein the developing device includes the developing device according to claim 2.

13. An image forming apparatus comprising:
an image carrier; and
a developing device configured to form an image on the image carrier by performing development on the image carrier,
wherein the developing device includes the developing device according to claim 3.

14. An image forming apparatus comprising:
an image carrier; and
a developing device configured to form an image on the image carrier by performing development on the image carrier,
wherein the developing device includes the developing device according to claim 4.

15. An image forming apparatus comprising:
an image carrier; and
a developing device configured to form an image on the image carrier by performing development on the image carrier,
wherein the developing device includes the developing device according to claim 5.

16. An image forming apparatus comprising:
an image carrier; and
a developing device configured to form an image on the image carrier by performing development on the image carrier,
wherein the developing device includes the developing device according to claim 6.

17. An image forming apparatus comprising:
an image carrier; and
a developing device configured to form an image on the image carrier by performing development on the image carrier,
wherein the developing device includes the developing device according to claim 7.

18. An image forming apparatus comprising:
an image carrier; and
a developing device configured to form an image on the image carrier by performing development on the image carrier,
wherein the developing device includes the developing device according to claim 8.

19. An image forming apparatus comprising:
an image carrier; and
a developing device configured to form an image on the image carrier by performing development on the image carrier,
wherein the developing device includes the developing device according to claim 9.

20. An image forming apparatus comprising:
an image carrier; and
a developing device configured to form an image on the image carrier by performing development on the image carrier,
wherein the developing device includes the developing device according to claim 10.
